(19) United States
(12) Patent Application Publication
(10) Pub. No.: US 2014/0173956 A1
(43) Pub. Date: Jun. 26, 2014

(54) SIGNAGE SYSTEMS

(71) Applicant: T.M. SHEA PRODUCTS, INC., Troy, MI (US)

(72) Inventors: Thomas M. SHEA, Troy, MI (US); Jacob SCOBIE, Roseville, MI (US); Roger MAGERMAN, Pontiac, MI (US)

(73) Assignee: T.M. SHEA PRODUCTS, INC., Troy, MI (US)

(21) Appl. No.: 14/193,472

(22) Filed: Feb. 28, 2014

Related U.S. Application Data
(63) Continuation of application No. 13/489,919, filed on Jun. 6, 2012, now abandoned.
Application No. 13/489,919 is a continuation of application No. 13/072,191, filed on Mar. 25, 2011, now abandoned.

(51) Int. Cl. G09F 7/18

(52) U.S. Cl. CPC G09F 7/18
USPC 40/606.01

(57) ABSTRACT

A system for supporting one or more contiguous overhead signs or portions thereof. The system includes a plurality of sign support members, and a plurality of connectors for coupling adjacent support members along a common longitudinal axis. At least one connector is slidably receivable by the adjacent support members in corresponding channels thereon.

### CROSS-REFERENCE TO RELATED APPLICATIONS

This application is a continuation of U.S. Ser. No. 13/489,919 filed 6 Jun. 2012 which claims priority to U.S. Ser. No. 13/072,191 filed 25 Mar. 2011, which claims the benefit of U.S. 61/417,539 filed on 25 Mar. 2010, which claims priority to U.S. Ser. No. 11/620,866 filed 8 Jan. 2007 (now U.S. Pat. No. 8,001,712), which claims the benefit of U.S. 60/756,879 filed 6 Jan. 2006. The entire disclosures of the above applications are incorporated herein by reference.

### FIELD

The present teachings generally relate to retail signage systems.

### DISCUSSION

A multitude of product and product categories crowd the aisles and merchandise displays of retail stores. Signage systems can be used to showcase products or product categories, attract attention and provide guidance to different sections of the store. Additionally, with fluctuating market demands, seasonal space requirements and influx of new products, there is a constant need to assemble, disassemble, change or remove overhead sign supports quickly and easily while attaining optimal visibility.

Although the existing signage supports can be satisfactory for their intended purposes, there is still a need for signage systems that are versatile, lightweight and easy to install, assemble and/or disassemble.

### SUMMARY

In one aspect, an overhead sign system according to the present teachings can include at least one support member having a panel having first and second surfaces. The first surface can define a clip for supporting the sign. The second surface can define at least one longitudinal channel. The overhead sign system can further include at least one arm for supporting the support member on a support surface, and at least one connector slidably received in the longitudinal channel of the support member.

In another aspect, an overhead sign system according to the present teachings can include at least one pair of first and second longitudinal clip elements for holding the sign or portion thereof, at least one pair of first and second receiver elements, each receiver element having a longitudinal inner channel for receiving one of the clip elements therein, and having an outer channel, at least one hanger connector having an elongated projection received in outer channel, and at least one arm coupled to the hanger connector at a first end and to a support surface at a second end.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present invention will become more fully understood from the detailed description and the accompanying drawings, wherein:

FIG. 1A is a perspective view of an overhead signage system according to the present teachings, the system shown above a merchandise display;

FIG. 1B is a perspective view of an overhead signage system according to the present teachings;

FIGS. 2A-E illustrate assembly and installation procedures the overhead signage system of FIG. 1B;

FIG. 3A is a side view of a detail of an overhead signage system according to the present teachings;

FIG. 3B is a side view of a detail of an overhead signage system according to the present teachings;

FIG. 3C is a side view of a detail of an overhead signage system according to the present teachings;

FIG. 4A is a perspective view of an overhead signage system according to the present teachings, the system shown above a merchandise display;

FIG. 4B is a perspective view of an overhead signage system according to the present teachings; and

FIGS. 5A-E illustrate assembly and installation procedures for the overhead signage system of FIG. 4B.

FIG. 6A is a perspective view of another overhead signage system according to the present teachings.

FIG. 6B is a perspective view similar to FIG. 6A shown with a portion of the overhead signage system removed for purposes of illustration.

FIG. 7A is a perspective view of another overhead signage system according to the present teachings.

FIG. 7B is a perspective view similar to FIG. 7A shown with a portion of the overhead signage system removed for purposes of illustration.

FIG. 8A is a perspective view of another overhead signage system according to the present teachings.

FIG. 8B is a rear perspective view of one of the headers of FIG. 8A.

FIG. 9A is a perspective view of another overhead signage system according to the present teachings, the overhead signage system shown mounted to a pegboard.

FIG. 9B is a perspective view of a portion of the overhead signage system of FIG. 9A shown removed from the pegboard for purposes of illustration.

FIG. 10A is a perspective view of another overhead signage system according to the present teachings.

FIG. 10B is a perspective view of a portion of the overhead signage system of FIG. 10A.

FIG. 11 is a perspective view of another overhead signage system according to the present teachings.

FIG. 12 is a perspective view of another overhead signage system according to the present teachings.

FIG. 13 is a perspective view of a signage system according to the present teachings, the system shown extending above a merchandise display.

FIG. 14 is a side view of the signage system of FIG. 1, shown removed from the merchandise display for purposes of illustration.

FIG. 15 is a perspective view of another signage system according to the present teachings, the system shown extending from a merchandise display.

FIG. 16 is a side view of the signage system of FIG. 3, shown removed from the merchandise display for purposes of illustration.

FIG. 17 is a perspective view of another signage system according to the present teachings, the system shown extending from a merchandise display.

FIG. 18 is a perspective view of another signage system according to the present teachings.

FIG. 19 is another perspective view of the signage system of FIG. 18.

FIG. 20 is a perspective view of another signage system according to the present teachings, the signage system shown secured to a shelf.

FIG. 21 is another perspective view of the signage system of FIG. 8, the signage system illustrated as it is attached to the shelf.

FIG. 22 is a perspective view of another signage system of the present teachings.

FIGS. 23 and 24 illustrate attachment of the signage system of FIG. 10 to a pegboard wall.

FIG. 25 is a perspective view of another signage system in accordance with the present teachings.

FIG. 25A is a top view of one of the mounting assemblies of FIG. 25.

FIGS. 26 and 27 illustrate attachment of the signage system of FIG. 13 to exemplary retail structure.

FIG. 28 is a perspective view of another signage system of the present teachings.

### DESCRIPTION OF VARIOUS ASPECTS

The following description is merely exemplary in nature and is in no way intended to limit the invention, its application, or uses.

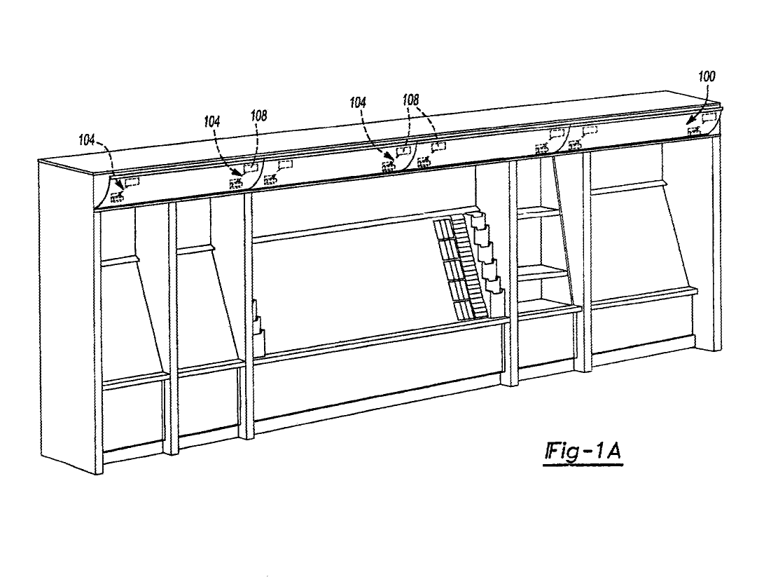

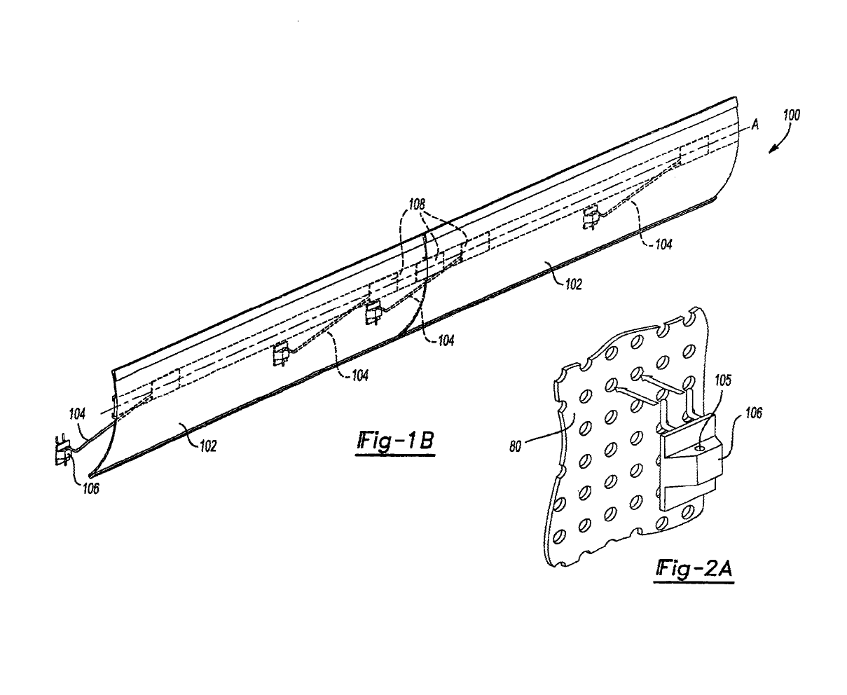

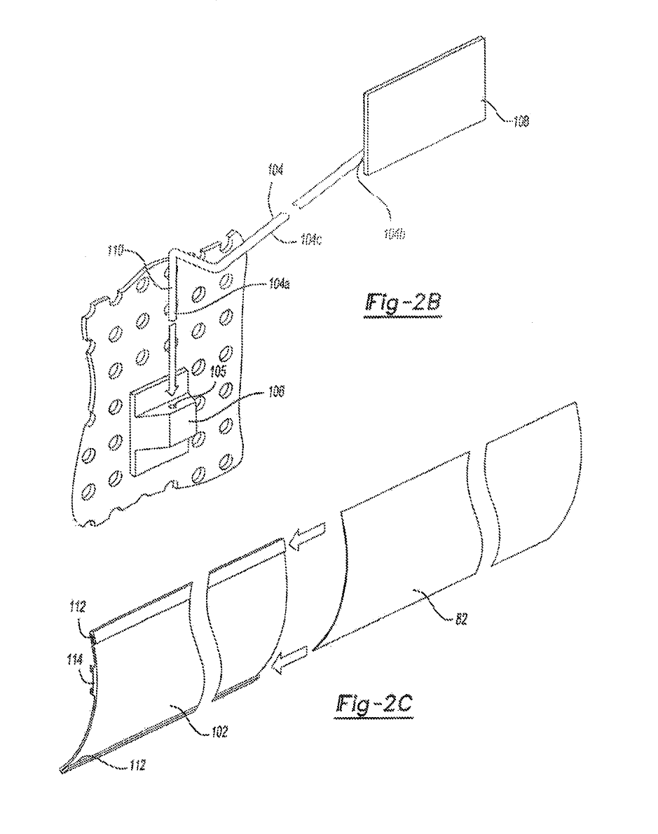

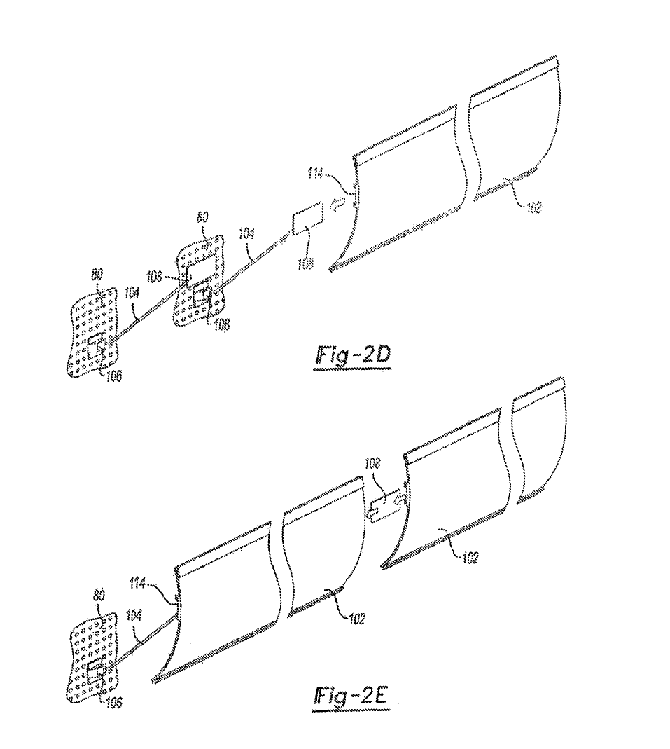

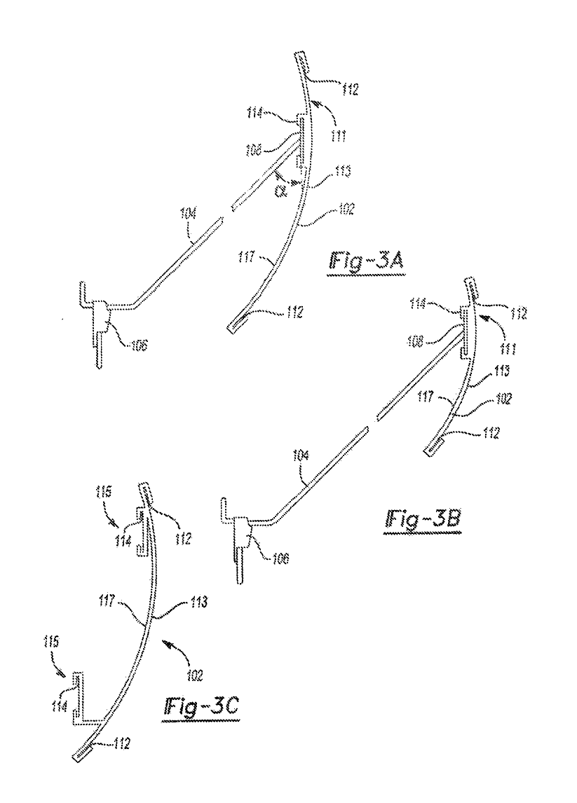

Referring to FIG. 1A, an exemplary overhead signage system 100 according to the present teachings is shown in connection with a merchandise display. The overhead signage system 100 can be used to support one or more signs 82, or contiguous portions thereof. Referring to FIGS. 1B and 2A-E, the overhead signage system 100 can include one or more support members 102 having a longitudinal axis A, and a plurality of arms 104 coupled to the support members 102. Referring to FIGS. 3A-C, each support member 102 can be an integral panel, substantially flat or curved, and having front and back surfaces 113, 117. The front surface 113 can include folded edges 112 defining a C-shaped clip 111 for holding the sign 82 or portion thereof. The back surface 117 can include one or more longitudinal channels 114 defined on a channel structure 115 of the back surface 117, as shown in FIGS. 3A-C. The channels 114 can slidably receive connectors 108 coupling the arms 104 to the support members 102, and/or coupling adjacent support members 102 to each other, as discussed below.

Referring to FIGS. 2A-E, the arms 104 can be configured for hanging the sign 82 on the support members 102 at an angle α relative to a support surface 80 or relative to a surface of the connector 108. The support surface 80 can be a wall, a pegboard, or other surface adjacent to the merchandise display. Each arm 104 can be a wire or other thin elongated member which can be straight or piecewise straight, although curved members can also be used. The arm 104 can include first and second ends 104a, 104b and a central portion 104c. The first end 104a can be configured to be removably received in a bore 105 of a mounting bracket 106. The arm 104 can include an end segment 110 adjacent to the first end 104a, which can be angled relative to the central portion 104c in or out of plane relative to central portion 104c such that the arm 104 can be positioned at a desired angle relative to the support surface 80. Further, the end segment 110 can be pivotably received in the bore 105 for allowing the arm 104 to rotate relative to the mounting bracket 106.

The second end 104b of the arm 104 can be modularly or integrally coupled to one of the connectors 108. The connector 108 can be a plate or other element configured to be slidably received in one of the channels 114 of the support member 102, as illustrated in FIGS. 2D, and 3A-B. Additionally, the connector 108 can be used independently of the arm 104 for connecting two adjacent support members 102 to each other, as illustrated in FIG. 2E, showing one of the connector 108 at least partially received in the channels 114 of two adjacent support members 102.

The overhead signage system 100 can be assembled and installed as illustrated in FIGS. 2A-E. The mounting brackets 106 can be inserted into the pegboard or otherwise mounted on the support surface 80 at desired distances therebetween, and in one or more rows corresponding to the number of channels 114 of the support members 102, as shown in FIG. 2A. The arms 104 can be removably coupled to the mounting brackets 106 by inserting the corresponding end segments 110 into the bores 105, as shown in FIG. 2B. The sign 82 can be inserted into the C-shaped clip 111 of the support member 102, as shown in FIG. 2C. The connectors 108 of the arms 104 can be inserted into the channel 114 of the support member 102, as shown in FIG. 2D. Two support members 102 can be connected longitudinally to each other by inserting a common connector 108 at adjacent ends of their channels 114, as shown in FIG. 2E.

The support members 102 can be made of molded plastic, composite or other material in various sizes and shapes, as shown in FIGS. 3A-C. The arms 104, the connectors 108 and the brackets 106 can be metallic or made from other suitable material, and can also be provided in various sizes and shapes.

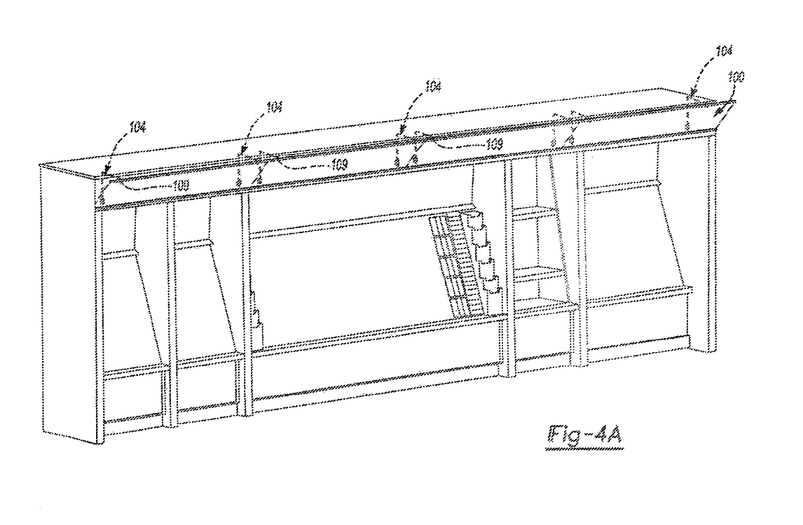

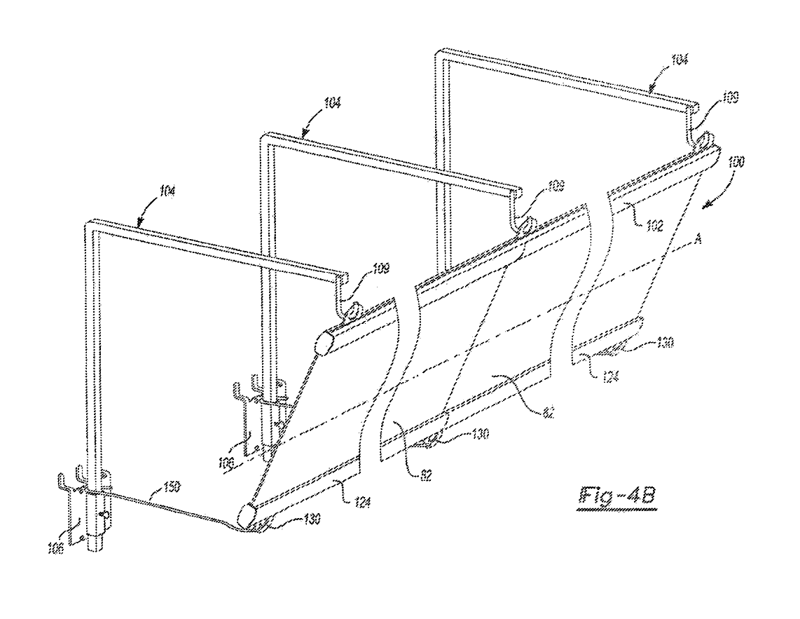

In one aspect, as illustrated in FIGS. 4A-B and 5A-E, the support members 102 can be modular and include two (upper and lower) separate and substantially parallel elongated clip elements 120, and two (upper and lower) elongated receiver elements 124, as illustrated in FIGS. 5C and 5D. The clip elements 120 can include inner grooves 122 for receiving the sign 82 without any back panels, or other supports. The clip elements 120 can be received into U-shaped channels or other inner channels 140 defined by the receiver elements 124 and configured to slidably receive and support the clip elements 120 therein. End covers 126 can be coupled to the free ends of the support members 102 to secure the clip elements 120 into the receiver elements 124, preventing relative sliding and providing a neat and finished appearance, as shown in FIGS. 5E and 4B. The end covers 126 can include one-sided pins or other projections 128 which can be inserted in outer grooves/slots/channels 142 of the receiver elements 124. Hanger connectors 130 having openings 132 and one- or two-sided oppositely extending pins or projections 128 can be slidably received in the outer grooves 142 of the receiver elements 124. The hanger connectors 130 can be used for coupling the arms 104 with the support members 102 and/or couple two adjacent support members 102 to each other, as shown in FIGS. 4B and 5E.

The support members 102 with the sign 82 attached therebetween can be supported by angled support arms 104, which can be substantially L-shaped and including first and second substantially orthogonal arm portions 103, 101. The free end 104b of the second arm section 101 can be coupled to a hook or other hanging device 109, as shown in FIG. 5B. The free end 104a of the first arm portion 103 can be removably received in the bore 105 of the mounting bracket 106 and secured in position with a thumbscrew 107.

The overhead signage system 100 of FIG. 4A-B can be assembled and installed as illustrated in FIGS. 5A-E. The mounting brackets 106 can be inserted into the pegboard or otherwise mounted on the support surface 80 at desired distances therebetween at the same height in one row, as shown in FIG. 5A. The arms 104 can be coupled to the mounting brackets 106 by inserting their first ends 104a into the bores 105, as shown in FIG. 5B. The sign 82 can be installed between the clip elements 120, as shown in FIG. 5C. The clip elements 120 with the sign 82 supported therebetween can be coupled to the receiver elements 124, as shown in FIG. 5D. The end covers 126 and the hanger connectors 130 can be coupled to the support members 102, as shown in FIG. 5E. The hooks 109 can be coupled to the openings 132 of the hanger connectors 130 for hanging the support members 102, as shown in FIG. 4B. Elongated lower arms 150 can be used for coupling lower hanger connectors 130 to the mounting brackets 106. The lower arms 150 can be, for example, wire elements terminating in wire hooks, and can be sized to hang the sign 82 at an angle appropriate for enhancing visibility and readability of the sign, as shown in FIGS. 4A-B. The angled arms 104 and the support members 102 can be made of lightweight strong material, such as aluminum or other metal, although plastics or composites can also be used. The angled arms 104 can be raised or lowered to provide a continuous signage surface with a common longitudinal axis A.

The overhead signage system 100 of the present teachings is a flexible and lightweight system that can be used in many retail applications, allowing for eye-catching overhead graphics or other signage that can be placed in many sections of a store. The overhead signage system 100 can be provided with modularly connected support members 102 appropriate for accommodating signs of various lengths or contiguous signs. Further, the overhead signage system 100 can be easily assembled and disassembled, moved to new location and re-assembled in the same or different configuration.

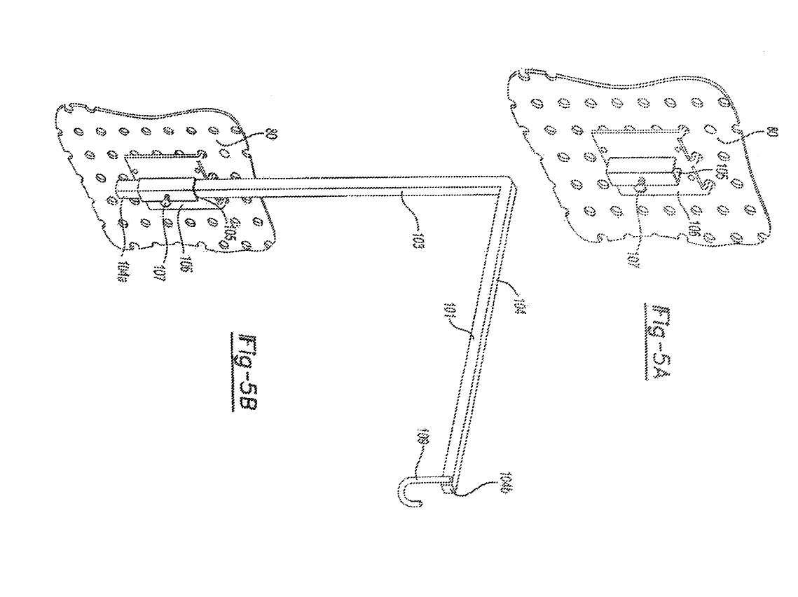

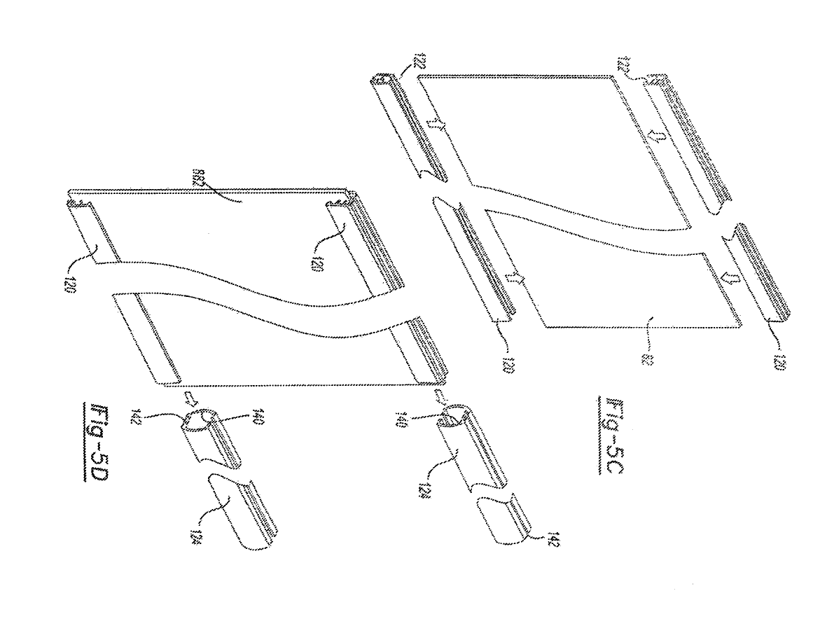

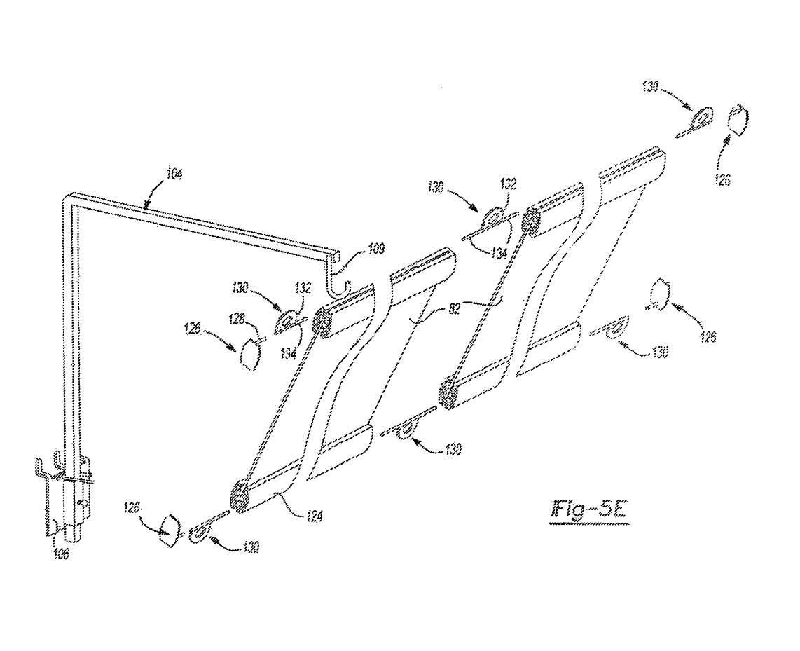

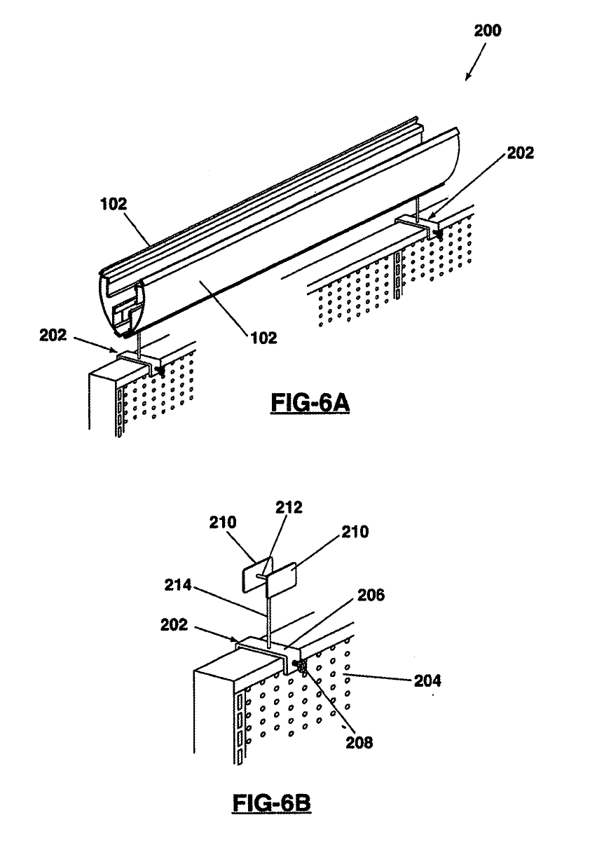

Turning to FIGS. 6A and 6B, another overhead signage system in accordance with the present teachings is illustrated and identified at reference character 200. Like reference characters will be used to identify similar elements to those previously introduced. The system 200 may include a pair of mounting members 202. As illustrated, the mounting members 202 may be secured to an upper end of a pegboard wall 204. The mounting members 202 may include a lower portion 206 defining a generally C-shaped opening for receiving the upper end of the wall 204. The lower portion 206 may be secured to the wall 204 with a thumbscrew 208 or other similar structure.

The mounting members 202 may additionally include an upper end having one or more mounting flanges 210. As shown in FIG. 6B, the upper end may include a pair of mounting flanges 210. Each mounting flange 210 may be adapted to be received with in a channel 114 defined in a rear surface of a support member 102, for example. The flanges 210 may be connected to each other through a link 212 and in turn connected to the lower portion 206 through another link 214. Two or more mounting members 202 may be used to support one or two support members 102.

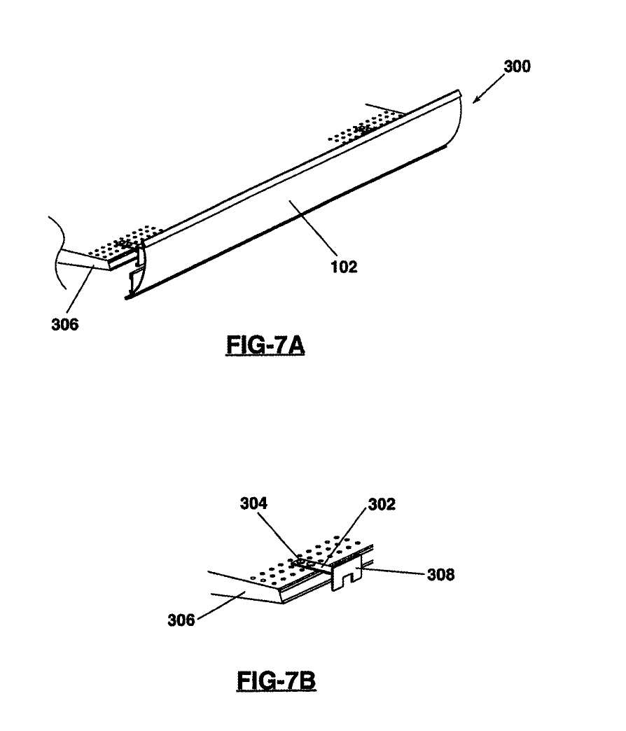

Turning to FIGS. 7A and 7B, another overhead signage system in accordance with the present teachings is illustrated and identified at reference character 300. Like reference characters will be used to identify similar elements to those previously introduced. The system 300 may include one or more shelf mounting members 302 and a support member 102. The shelf mounting member 302 includes a first end 304 for attachment to a shelf 306 and a second end carrying a mounting flange 308. The mounting flange 308 is adapted to be received with in a channel 114 defined in a rear surface of a support member 102, for example.

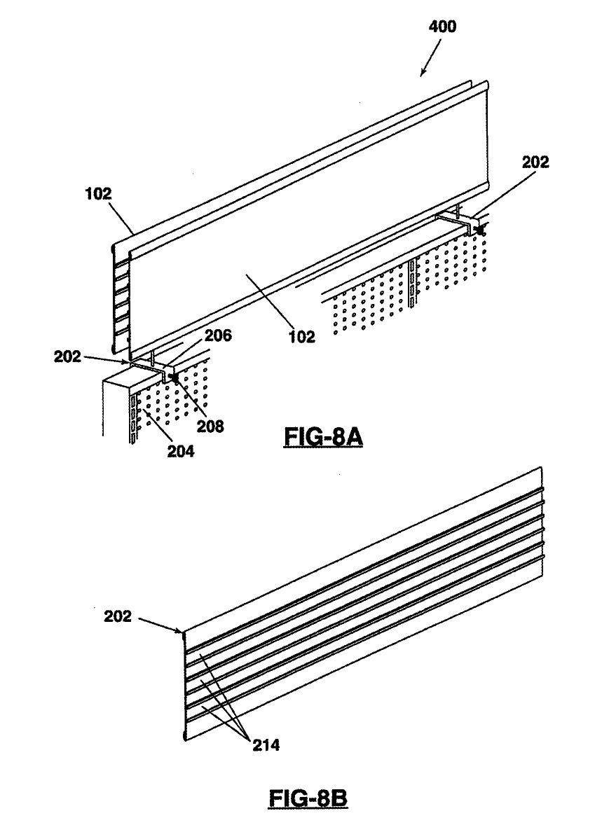

Turning to FIGS. 8A and 8B, another overhead signage system in accordance with the present teachings is illustrated and identified at reference character 400. Like reference characters will be used to identify similar elements to those previously introduced. The system 400 may include a pair of mounting members 202. As illustrated, the mounting members 202 may be secured to an upper end of a pegboard wall 204. The mounting members 202 may include a lower portion 206 defining a generally C-shaped opening for receiving the upper end of the wall 204. The lower portion 206 may be secured to the wall 204 with a thumbscrew 208 or other similar structure. As with the system 200, the mounting members 202 may additionally include an upper end having a pair of mounting flanges 210. Each mounting flange 210 may be adapted to be received with in a channel 114 defined in a rear surface of a support member 102, for example.

Turning to FIGS. 9A and 9B, another overhead signage system in accordance with the present teachings is illustrated and identified at reference character 500. Like reference characters will be used to identify similar elements to those previously introduced. The system 500 may include a wire arm 502. The wire arm 502 may be secured at a first end to the pegboard wall 204 with a bracket 106. The bracket 106 may include a pair of upwardly extending prongs 504 and a lower extending prong 506 for engaging holes of the pegboard wall 204. The wire arm 502 may be welded or otherwise permanently or removably secured to the bracket 106. A distal end of the wire arm 502 may carry one or more hooks 510 for supporting a sign 512.

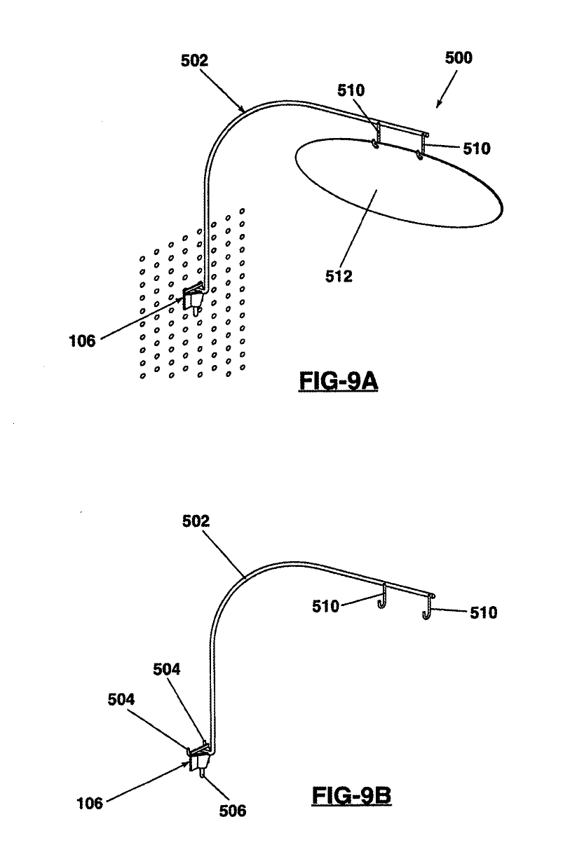

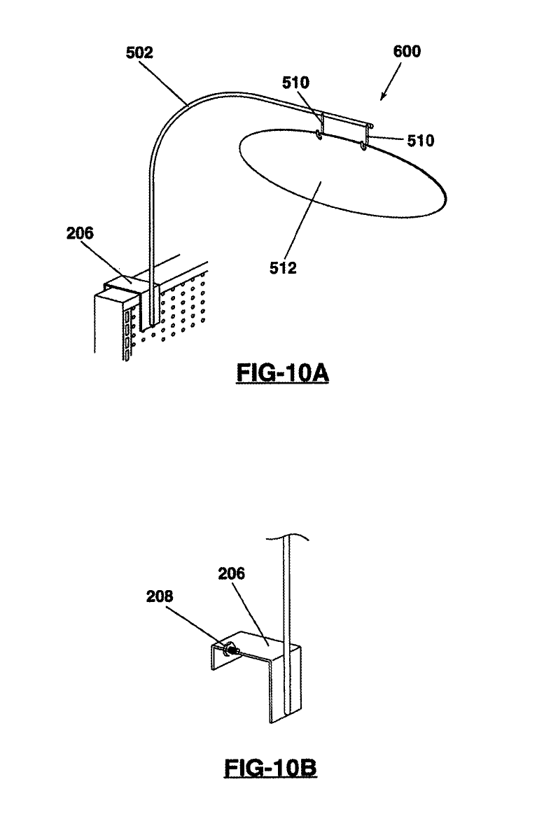

Turning to FIGS. 10A and 10B, another overhead signage system in accordance with the present teachings is illustrated and identified at reference character 600. Like reference characters will be used to identify similar elements to those previously introduced. The system 600 may include a wire arm 502. The wire arm 502 may be secured at a first end to a C-shaped member 206 for engaging an upper end of a pegboard wall 204. The member 206 may be secured with a thumb screw 208. The wire arm 502 may be welded or otherwise permanently or removably secured to the member 206. A distal end of the wire arm 502 may carry one or more hooks 510 for supporting a sign 512.

Turning to FIG. 11, another overhead signage system in accordance with the present teachings is illustrated and identified at reference character 700. Like reference characters will be used to identify similar elements to those previously introduced. The system 700 may include a tubular arm 702. The tubular arm 702 may have a generally rectangular cross section and may be secured at a lower end to a C-shaped member 206 for engaging an upper end of a pegboard wall 204. The member 206 may be secured with a thumb screw. The tubular arm 702 may be welded or otherwise permanently or removably secured to the member 206. An upper end of the tubular arm 702 may be secured to a generally horizontal arm 704. The arms 702 and 704 may be welded or otherwise secured to one another. The arm 704 may be slightly arcuate in shape such that ends 706 of the arm 704 is slightly displaced downwardly from a center of the arm 704. The ends 706 may each carry one or more hooks 510 for supporting a sign 512.

Turning to FIG. 12, another overhead signage system in accordance with the present teachings is illustrated and identified at reference character 800. Like reference characters will be used to identify similar elements to those previously introduced. The system 800 may include a pair of wire arms arm 802. The wire arms 802 may be secured at their lower ends to one another and to a C-shaped member 206 for engaging an upper end of a pegboard wall 204. The member 206 may be secured with a thumb screw. The wire arms 802 may be welded or otherwise permanently or removably secured to the member 206. The arms 802 may be arcuate in shape. Ends 806 of the arms 802 may each carry one or more hooks 510 for supporting a sign 512.

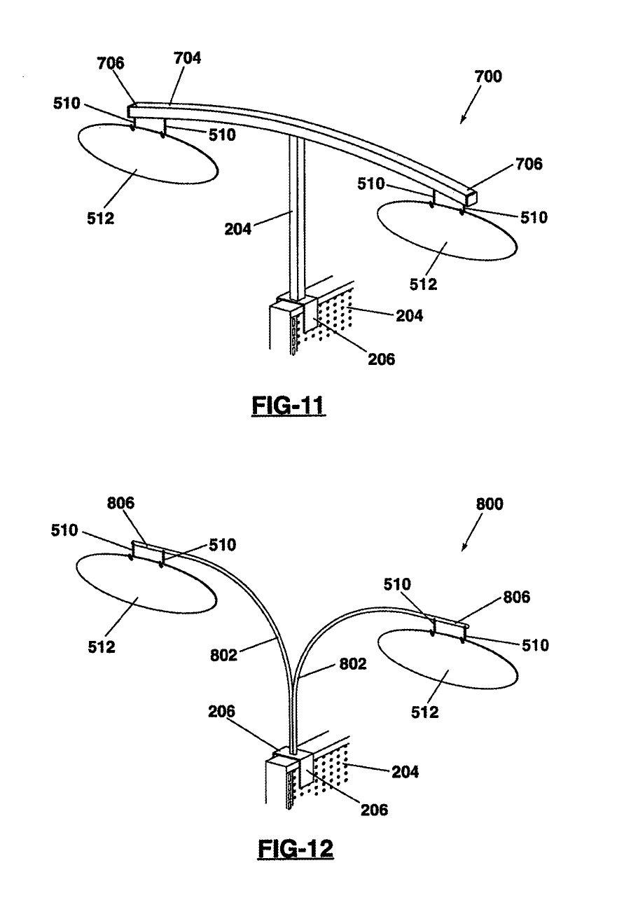

With reference to FIGS. 13 and 14, a signage system in accordance with the present teachings is illustrated and generally identified at reference character 1100. It will be understood that the signage system 1100 may be used to support one or more retail signs (not particularly shown). Similar systems are shown in cooperation with retail signs in common assigned U.S. U.S. Ser. No. 11/620,866 which is hereby incorporated by reference as if fully set forth herein.

The signage system 1100 is generally shown to include an arm 1102, a first mounting bracket 1104 and a second mounting bracket 1106. The arm 1102 may cooperate with similarly constructed arms to support retail signage generally in the manner shown and described in U.S. Ser. No. 11/620,866. As shown in FIG. 13, the system 1100 may be used to support the retail signage from a pegboard wall 1108.

The arm 1102 may include a first portion or vertically extending portion and a second portion or horizontally extending portion. As illustrated, the arm 1102 is constructed of a first piece that defines the vertically extending portion and part of the horizontally extending portion. A second piece telescopically cooperates with the part of the horizontally extending portion of the first piece to provide adjustability of the second bracket 1106. A spring biased button may be carried by the horizontally extending portion of the first piece and cooperate with apertures of the second piece to conventionally lock the second piece relative to the first piece. The vertically extending and horizontally extending portions may be constructed of a greater or lesser number of pieces. In this regard, the vertically extending portion may include multiple pieces to similarly provide for telescopic adjustment.

The first bracket 1104 may be welded or otherwise securely fastened to a lower end of the vertically extending portion. For example, the first bracket 1104 may be secured to the lower end of the vertically extending portion with a faster. The first bracket 1104 may be generally U-shaped and define an opening for receiving an upper end of the pegboard wall 1108. A fastener may extend through apertures in downwardly extending legs of the bracket 1104 and may pass through the pegboard wall 1108 for purposes of securing the bracket 104 to the pegboard wall 1108.

The second bracket 1106 may be fastened or otherwise securely fastened to a distal or free end of the horizontally extending portion. As shown, the bracket 1106 may be secured to the horizontally extending portion with a fastener passes through an aperture in the bracket 1106 and threadable engages the end of the horizontally extending portion. Alternatively, the second bracket 106 may be welded to the distal end of the horizontally extending portion. The second bracket 1106 may define upper and lower flanges adapted to be received within channels defined by the retail signage. Such an arrangement is shown and further described in U.S. Ser. No. 11/620,866.

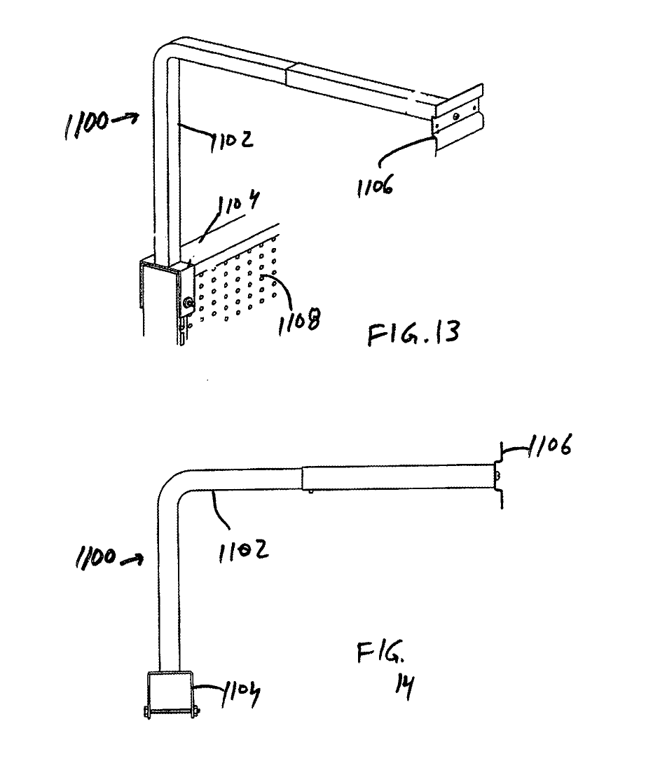

Turing to FIGS. 15 and 16, another signage system in accordance with the present teachings is illustrated and generally identified at reference character 1200. The signage system 1200 is similar to the signage system 1100. For this reason, like reference characters will be used to identify similar components throughout the drawings.

The signage system 1200 is generally shown to include an arm 1202, a first mounting bracket 1204 and a second mounting bracket 1106. As above, the arm 1202 may cooperate with similarly constructed arms to support retail signage. The arm 1202 is adapted to be horizontally oriented. As illustrated, the arm 1202 is constructed of a first piece and a second piece telescopically cooperates with the first piece to provide adjustability of the second bracket 106 relative to the pegboard wall 1108. A spring biased button may be carried by the first piece and cooperate with apertures of the second piece to conventionally lock the second piece relative to the first piece. It will be understood that the arm 1202 may be constructed of a greater or lesser number of pieces.

The first bracket 1204 may be welded or otherwise securely fastened to an end of the arm 1202. For example, the first bracket 1204 may be secured to the end of the arm 1202 with a faster. The first bracket 1204 may be generally planar and may define an opening for receiving a faster for securing the arm 1202 to the pegboard wall 1108. The fastener may include a hooked end for insertion into a slot of an upwardly extending member of the pegboard wall 1108, a threaded portion, and a nut threadable carried on the threaded portion. Tightening of the nut may conventionally draw the bracket 1204 against the pegboard wall 1108 and thereby secure the arm 1202 to the pegboard wall 1108.

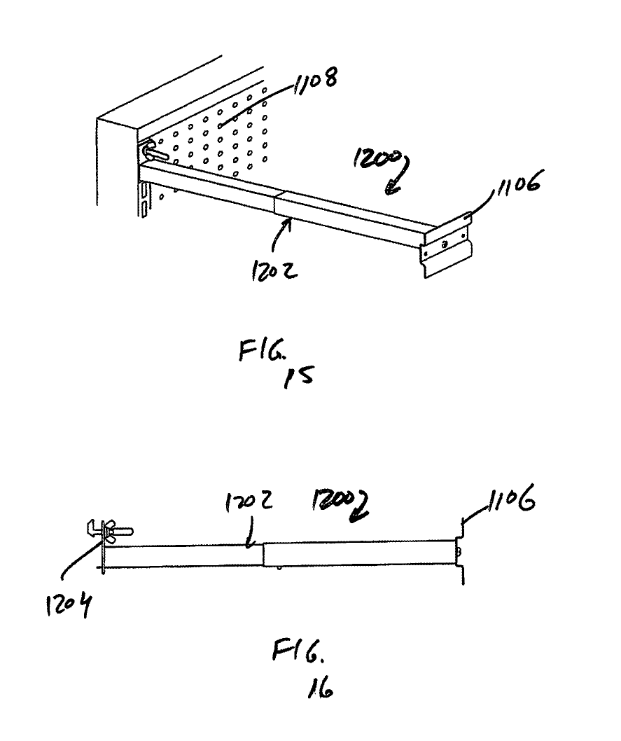

With reference now to FIG. 17, another signage system in accordance with the present teachings is illustrated and generally identified at reference character 1300. Like reference characters will be used throughout the drawings to identify components similar to those introduced above.

The signage system 1300 is generally shown to include an arm 1302, a first mounting bracket 1304 and a second mounting bracket 1306. As illustrated, the arm 1302 is constructed of a single piece. Alternatively, the arm 1302 may be constructed of multiple pieces that are telescopically interconnected for purposes of adjustability.

The first bracket 1304 may be welded or otherwise securely fastened to an end of the arm 1302. For example, the first bracket 1304 may alternatively be secured to the end of the arm 1302 with a faster. The first bracket 1304 may be generally planar and may include a plurality of rearwardly extending prongs for engaging multiple holes of the pegboard wall 1108. It will be understood that the rearwardly extending prongs and their cooperation with the pegboard wall 1108 are conventional insofar as the present teachings are concerned.

The second bracket 1306 may be generally planar and may be secured to an opposite end of the arm 1302. Securement may be by way of welding, fastening or any other manner well known in the art. The bracket 1306 may be secured to the end of the arm 1302 at an angle.

The system 1300 may further include a carrier 1308. The carrier 1308 may include a generally planar portion and a lower flange. The carrier 1308 may be particularly adapted for the display of a parts manual or similar literature. In the embodiment illustrated, the carrier 1308 is adhesively mounted to the second bracket 1306. The carrier 1308 may be alternatively mounted to the second bracket 1306 within the scope of the present teachings. Further in the embodiment illustrated, the carrier 1308 may be constructed of a clear acrylic material. The carrier 1308 may be alternatively constructed of another material, including both clear and opaque materials.

The system 1300 may include a plurality of rings 1310. The rings 1310 may pass through a corresponding plurality of apertures provided in the carrier 1308. The rings 1310 may be used to secure the parts manual or similar literature.

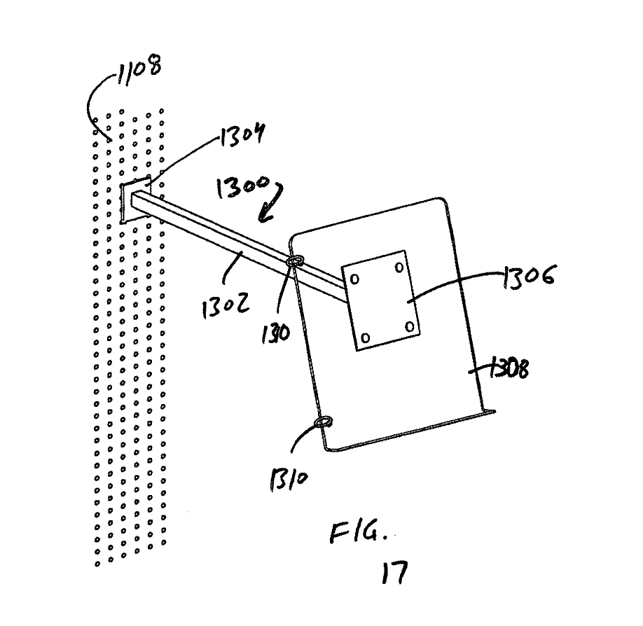

With reference now to FIGS. 18 and 19, another signage system in accordance with the present teachings is illustrated and generally identified at reference character 1400. Like reference characters will be used throughout the drawings to identify components similar to those introduced above. It will be understood that the system 1400 is identical to the system 1300 except that the system 1400 incorporates an alternative first bracket 1204. It will be further understood that the first bracket 1204 is identical to the first bracket 1204 described above with respect to the system 2100.

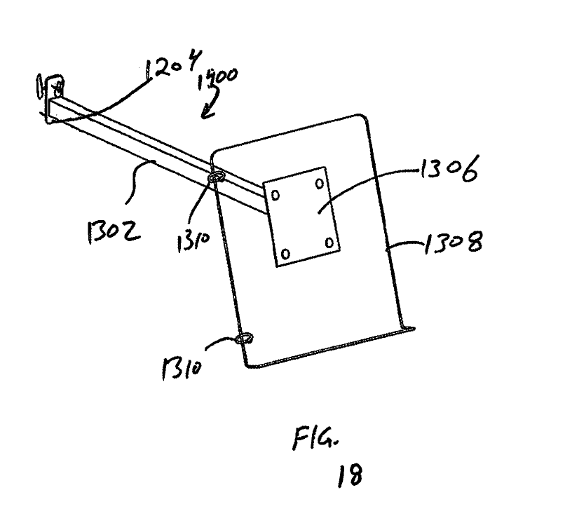

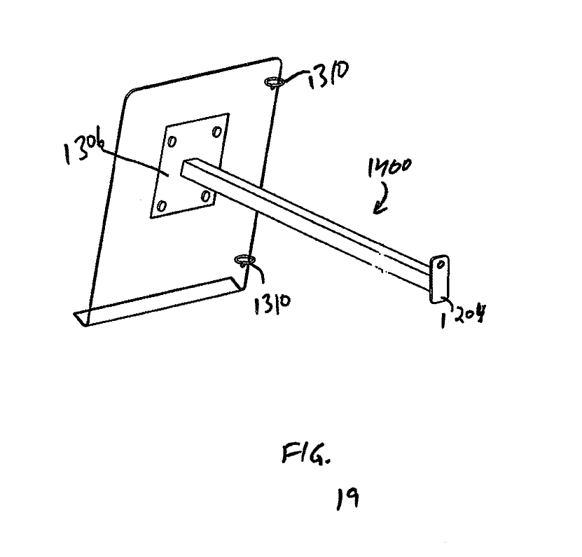

Turning to FIGS. 20 and 21, another signage system in accordance with the present teachings is illustrated and generally identified at reference character 1500. FIG. 20 illustrates the signage system 1500 secured to a shelf 1502. FIG. 21 illustrates the signage system 1500 as it is attached to the shelf 1502.

The signage system 1500 may generally include a bracket 1501 having a first planar portion 1504 and a second planar portion 1506. The first and second planar portions 1504 and 1506 may be formed of a single sheet of metal or other suitable material. Where the bracket 1501 is formed of metal, the first portion 1504 may be bent relative to the second portion 1506 such that the first and second portions are oriented orthogonal to one another.

The second portion 1506 may define a mounting portion. The second portion 1506 may be located adjacent an underside of the shelf 1502. The second portion 1506 may include a slot for receiving one or more fasteners. Alternatively, the second portion 1506 may define a plurality of apertures for receiving the fasteners. The slot may be aligned with holes in the shelf 1502 and the fasteners may be passed through the holes in the shelf 1502 and the slot for securing the second portion 1506 of the bracket to the shelf 1502.

The first portion 1504 of the bracket may define an opening for accommodating a downwardly extending lip of the shelf 1502. The opening may be generally U-shaped. Alternatively, the opening may be of any suitable geometry for accommodating the downwardly extending lip of the shelf 1502. The first portion 1504 may carry UPC codes on both sides and may also carry signage at an upper end.

The system 1500 may further include a hook 1510. The hook 1510 may be generally in the shape of a W. Describing the hook 1510 further, the W-shape may include a central U-shaped portion and two U-shaped sides. Each of the U-shaped sides may have a common leg with the central U-shaped portion. The hook 1510 may be received within an aperture defined by the first portion 1504 of the bracket 1501. As illustrated in FIG. 20, the hook 1501 may be balanced within the aperture such that one of the U-shaped sides is on a first side of the bracket 1501 and the other of the U-shaped sides is on a second side of the bracket 1501. Signage may be suspended from both of the U-shaped sides.

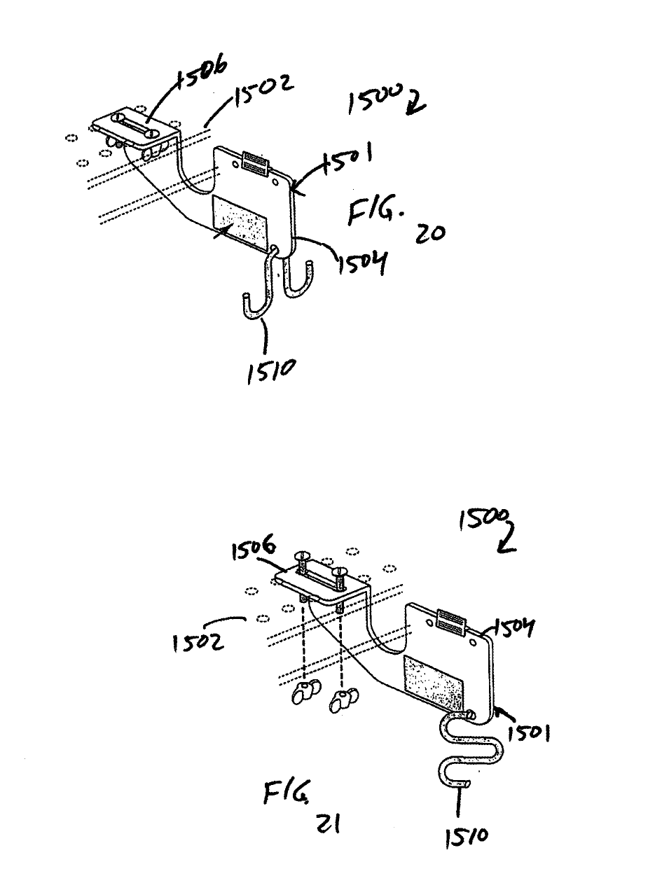

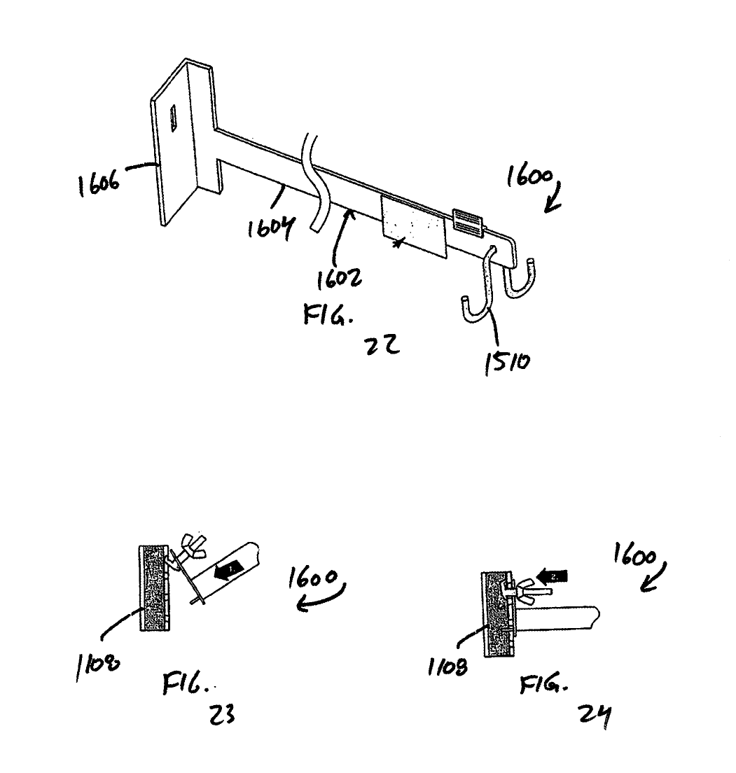

With reference to FIGS. 22-24, another signage system in accordance with the present teachings is illustrated and generally identified at reference at character 1600. Like reference characters will be used throughout the drawings to identify components similar to those introduced above. FIGS. 23 and 24 illustrate attachment of the signage system 1600 to a pegboard wall 1108.

The signage system 1600 is illustrated to generally include a bracket 1602 and a hook 1510. The hook 1510 will be understood to be identical to the hook 1510 described above. The bracket 1602 may include a first portion 1604 and a second portion 1606. The first and second portions 1604 and 1606 may be formed of a single sheet of metal or other suitable material. Where the bracket 1602 is formed of metal, the first portion 1604 may be bent relative to the second portion 1606 such that the first and second portions are oriented orthogonal to one another.

The second portion 1606 may define a mounting portion. In the embodiment illustrated, the second portion 1606 may be secured to a pegboard wall or other retail structure. The second portion 1606 may be secured to the pegboard wall with a fastener in the manner discussed above with respect to the system 1200.

The first portion 1604 of the bracket 1602 may define an arm. The arm may carry UPC codes on both sides and may also carry further signage. The hook 1510 may be suspended from the bracket 1602 in the manner discussed above with respect to the system 1500. The hook 1510 may be used to suspend signage as discussed above.

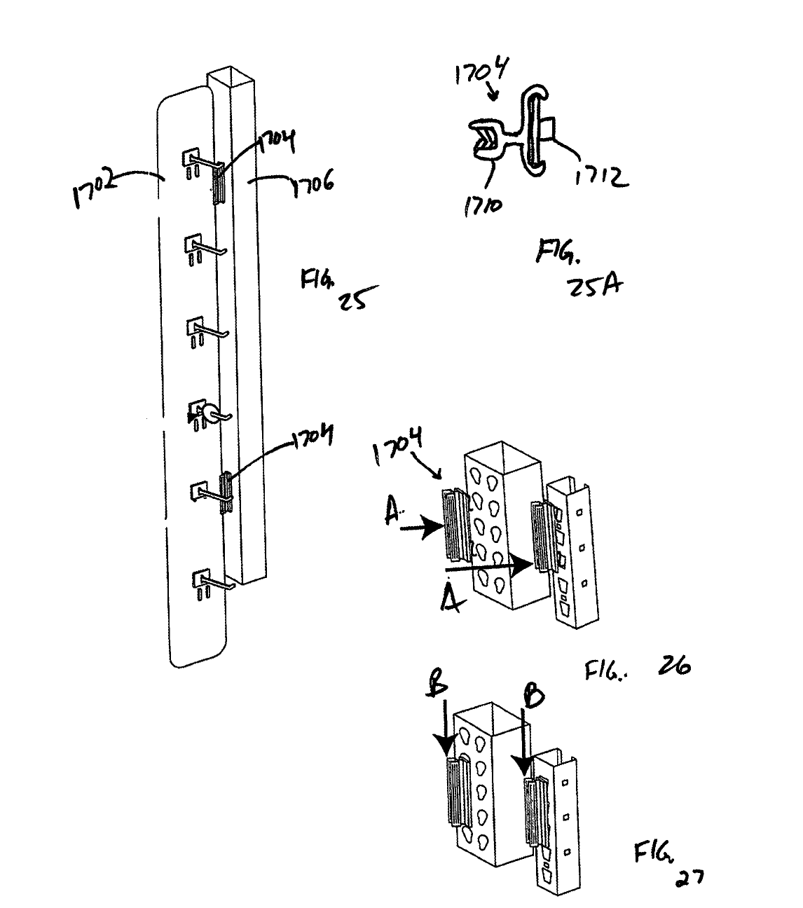

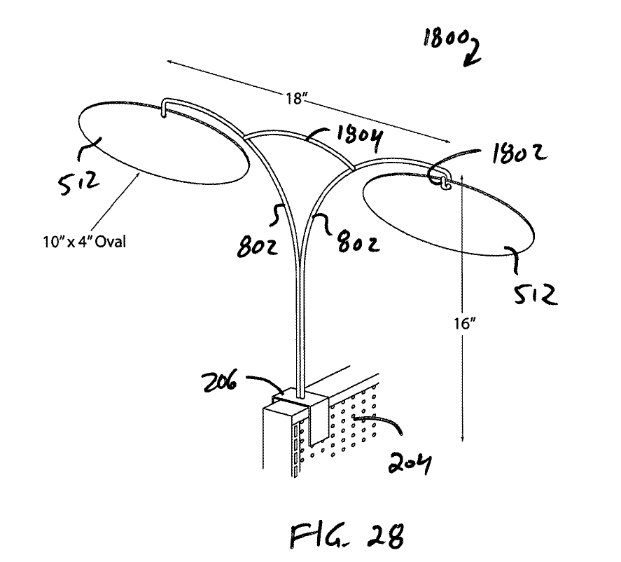

With reference to FIGS. 25-27, another signage system in accordance with the present teachings is illustrated and generally identified at reference at character 1700. FIGS. 26 and 27 illustrate attachment of the signage system 1700 to exemplary retail structures.

The signage system 1700 is generally illustrated to include a sign 1702 and one or more mounting assemblies 1704. The sign 1702 will be understood to be generally planar and constructed of cardboard or other similar material. The sign may carry hooks or other features for suspending product for retail sale.

As shown in FIG. 25A, a pair of mounting assemblies 1704 are shown securing the sign 1702 to a retail structure 1706. It will be understood that a greater or lesser number of mounting assemblies 1704 may be used within the scope of the present teachings. The number of mounting assemblies 1704 employed will depend on the holding strength of the mounting assemblies 1704 and the weight of the sign 1702.

As perhaps best shown in the top view of FIG. 25A, the mounting assemblies 1704 may be first of first and second pieces 1710 and 1712. The first piece 1710 may include a first portion or gripping portion for receiving the sign 1702. The first portion may include a relative stiff and generally U-shaped portion for receiving the sign. The first portion may further include a plurality of deflectable arms within the U-shaped portion constructed of a material having a relatively high co-efficient of friction. The arms may angle backward to allow insertion of the sign into the U-shaped portion and may be interleaved with the arms on the opposite side thereof to facilitate clamping of the sign 1702.

The second portion of the first piece 1710 may define a channel. The channel may slidable receive the second piece 1712. The second piece 1712 may include rearwardly extending hooks for mounting to a retail structure.

The first and second portions of the first piece 1710 may be connected by a flexible arm. The flexible arm may allow the sign to be readily deflected relative to the retail structure when displayed.

With reference to FIGS. 26 and 27, attachment of the mounting assemblies 1704 to conventional retail structures is shown. The mounting assemblies 1704 may be secured to pallet racks or HyperMax™ tubes. Alternatively, the mounting assemblies 1704 may be mounted to various other conventional structures within the scope of the present teachings. In a first step, the mounting assemblies 1704 are advanced toward the retail structures in a direction indicated by Arrows A. The hooks rearwardly extending from the second piece 1712 are received within holes of the retail structure. In a second step, the mounting assemblies 1704 are downwardly advanced in the direction of Arrows B.

Turning to FIG. 28, another overhead signage system in accordance with the present teachings is illustrated and identified at reference character 1800. Like reference characters will be used to identify similar elements to those previously introduced. The system 800 may include a pair of wire arms arm 802. The wire arms 802 may be secured at their lower ends to one another and to a C-shaped member 206 for engaging an upper end of a pegboard wall 204. The member 206 may be secured with a thumb screw. The wire arms 802 may be welded or otherwise permanently or removably secured to the member 206. The arms 802 may be arcuate in shape. Ends 806 of the arms 802 may each carry one or more hooks 1802 for supporting a sign 512. The arcuate arms 802 may be braced by a bracing member 1804. A generally v-shaped opening may be defined between the arcuate arms 802 and the bracing member 1804. As illustrated, the bracing member 1804 may be arcuate.

While specific examples and alternatives have been described in the specification and illustrated in the drawings, it will be understood by those skilled in the art that various further changes may be made by and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A system for supporting one or more overhead signs or portions thereof, the system comprising:
a plurality of sign support members; and
a plurality of connectors for coupling adjacent support members along a common longitudinal axis, at least one connector slidably receivable by the adjacent support members in corresponding channels thereon.

2. The system of claim 1, further comprising a plurality of arms coupled to the support members and configured for hanging the sign at an angle relative to a support surface.

3. The system of claim 2, wherein the arms are coupled to corresponding connectors, the connectors slidably received in the channels of the support members.

4. The system of claim 3, wherein each support member defines an integral panel having a front surface for supporting the sign and a back surface defining the channel.

5. The system of claim 4, wherein the support member defines more than one channel.

6. The system of claim 5, wherein each channel extends along the longitudinal axis.

7. The system of claim 3, wherein the arms are substantially L-shaped.

8. The system of claim 7, wherein the support members are modular elongated members comprising first and second clip elements for holding the sign, the first and second clip elements receivable in first and second receiver elements.

9. The system of claim 8, wherein each connector comprises a hanger opening and at least one projecting element.

10. The system of claim 9, wherein the channels are outer channels in the receiver elements and receive the projecting elements of the connectors.

11. The system of claim 10, further comprising end covers for the support members.

12. The system of claim 11, further comprising lowers arms for supporting the sign at an angle relative to the support surface.

13. The system of claim 2, further comprising a plurality of mounting brackets for removably coupling the arms to the support surface.

14. A system for supporting one or more contiguous overhead signs or portions thereof, the system comprising:
at least one support member comprising a panel having first and second surfaces, wherein the first surface defines a clip for supporting the sign, and the second surface defines at least one longitudinal channel;
at least one arm for supporting the support member on a support surface; and
at least one connector slidably receivable in the longitudinal channel of the support member.

15. The system of claim 14, wherein the clip is C-shaped.

16. The system of claim 15, wherein the panel is curved.

17. The system of claim 14, wherein the connector is coupled to the arm.

18. The system of claim 14, wherein the connector is coupled to the longitudinal channel of another adjacent support member.

19. A system for supporting one or more contiguous overhead signs or portions thereof, the system comprising:
at least one pair of first and second longitudinal clip elements for holding the sign or portion thereof;
at least one pair of first and second receiver elements, each receiver element having a longitudinal inner channel for receiving one of the clip elements therein, and having an outer channel;
at least one hanger connector having an elongated projection received in outer channel; and
at least one arm coupled to the hanger connector at a first end, and to a support surface at a second end.

20. The system of claim 20, further comprising another hanger connector with two opposite elongated projections for connecting two adjacent receiver elements to each other.
